(19) United States
(12) Patent Application Publication
(10) Pub. No.: US 2012/0024394 A1
(43) Pub. Date: Feb. 2, 2012

(54) METHOD FOR LOWERING THE PRESSURE IN A LOAD LOCK AND ASSOCIATED EQUIPMENT

(75) Inventors: Julien Bounouar, Annecy (FR); Jean-Marie Foray, Annecy (FR)

(73) Assignee: ADIXEN VACUUM PRODUCTS, Annecy (FR)

(21) Appl. No.: 13/140,189

(22) PCT Filed: Dec. 18, 2009
(86) PCT No.: PCT/FR2009/052607

§ 371 Date: Aug. 18, 2011

(30) Foreign Application Priority Data
Dec. 19, 2008 (FR) 0807191

(51) Int. Cl. F15D 1/00

(52) U.S. Cl. 137/14; 137/565.35

(57) ABSTRACT

The invention relates to a method for lowering the pressure in a device charge-discharge lock from atmospheric pressure to a sub-atmospheric transfer pressure, said lock comprising a chamber in which at least one substrate is arranged at atmospheric pressure, said method comprising: a first step (101), in which first primary pumping is carried out from atmospheric pressure to a first characteristic threshold, using a primary pump with limited pumping rate, while isolating a turbomolecular pumping of said chamber; a second step (102) following said first step (101), in which a second primary pumping is carried out, faster than in said first step, to a second characteristic threshold, maintaining the isolation of the turbomolecular pumping; a third step (103) following said second step (102), in which secondary pumping is performed using said turbomolecular pumping upstream from the first pumping, and the primary pump chamber is isolated. The invention also relates to a device for implementing the method.

The present invention relates to a method for lowering the pressure in a substrate load lock from atmospheric pressure to a low pressure, for loading a substrate into a handling chamber maintained at low pressure and for unloading the substrate therefrom. The invention also relates to equipment including a load lock adapted for the implementation of the method, for example equipment for manufacturing semiconductor components.

Some manufacturing methods include an important step in which a substrate is processed in a controlled atmosphere at very low pressure in a process chamber of a piece of equipment. For example, in semiconductor component manufacturing methods, it is desirable to keep the semiconductor substrate at very low pressure for carrying out plasma etching or deposition.

In order to maintain an acceptable production rate and to avoid the presence of any impurity or contamination, the pressure of the atmosphere surrounding the substrate is initially reduced to a low level by a load lock communicating with the process chamber.

For this purpose, the load lock includes a gas-tight chamber having a first door by means of which the interior of the enclosure communicates with an area at atmospheric pressure, such as a clean room or a mini-environment of equipment, for loading at least one substrate. The chamber of said load lock is connected to a gas pumping system which can lower the pressure in the chamber to an appropriate low level similar to that present in the process chamber, thus enabling the substrate to be transferred to the process chamber. Said load lock also includes a second door for unloading the substrate into the process chamber or into the transfer chamber after the evacuation of said load lock.

In the case of equipment comprising a plurality of process chambers, the load lock communicates with a transfer chamber kept at low pressure, which subsequently directs the substrate into the various process chambers.

By using the load lock it is thus possible to reduce the time required to change from atmospheric pressure to the low transfer pressure. It is also possible to reduce contamination in the process or transfer chamber.

The pressure in said load lock is generally reduced progressively in two successive steps. In the first step, a slow primary pumping is carried out from atmospheric pressure to a first characteristic threshold. The slow pumping is essential in order to prevent the solidification of certain types of gas present in the gaseous atmosphere of said load lock surrounding the substrate, for example in order to prevent the appearance of water crystals.

In the second step, the gaseous atmosphere is brought to the appropriate low pressure for transfer by faster primary pumping. However, it can be seen that the partial pressure of water vapor present in the residual gas mixture at the transfer pressure is not very satisfactorily evacuated by the primary pumping system. Water vapor can be relatively harmful to substrates, and can thus reduce production efficiency, notably as a result of corrosion of the metal layers of the substrate in semiconductor manufacturing processes.

Moreover, during the lowering of the pressure of the atmosphere in the load lock, degassing of the substrate inevitably occurs, and it is important for this degassing to be sufficient before the substrate is introduced into the process chamber. If this is not the case, degassing continues in the process chamber, and the gases given off by this later degassing form an additional source of contamination during processing.

WO 01/81651 discloses a gas pumping system comprising a primary pump connected by a pumping circuit to the load lock to pump the gases until an appropriate transfer pressure is reached. A turbomolecular pump is interposed in the pumping circuit between the primary pump and the load lock. Gas control means are provided to adapt the speed of the primary pump in order to avoid any condensation or solidification of the gases in the load lock. The turbomolecular pump is the only pumping element connected to the load lock. However, it has been found that pumping from atmospheric pressure using the turbomolecular pump can lead to problems of reliability of the turbomolecular pump and makes the pumping relatively noisy. Additionally, the drive means of the primary pump, used to adapt the speed of the pump, are complicated to implement.

The object of the invention is therefore to resolve the problems of the prior art by proposing a method for lowering the pressure in a load lock of equipment which is simple, inexpensive to implement, and compact, and which can prevent the solidification of certain types of gas at high pressure while reducing the quantity of residual water vapor in order to avoid its propagation into the process or transfer chamber at low pressure, without retarding the transfer of the substrate into the process chamber. The method is also intended to improve the degassing of substrates at the transfer pressure. The invention also proposes equipment for implementing the method.

For this purpose, the invention proposes a method for lowering the pressure in a load lock of equipment from atmospheric pressure to a sub-atmospheric transfer pressure, said load lock including a chamber in which at least one substrate is placed at atmospheric pressure, and a gas pumping system comprising a primary pump and a turbomolecular pump whose intake is connected to the chamber via a first isolation valve and whose delivery side is connected upstream of the primary pump to a primary pumping circuit, the gas pumping system additionally including a bypass circuit of the turbomolecular pump which communicates, on the one hand, with the chamber upstream of the first isolation valve, and, on the other hand, with the primary pumping circuit, the bypass circuit including a second isolation valve comprising flow limiting means which can be activated, and the primary pumping circuit including a third isolation valve positioned between the delivery side of the turbomolecular pump and the bypass circuit, the method including:
a first step in which the first and third isolation valves are closed, and the second isolation valve, for which the flow limiting means are activated, is opened, in order to carry out first primary pumping from atmospheric pressure to a first characteristic threshold through the bypass circuit of the primary pump whose pumping speed is limited, the intake of the operating turbomolecular pump being isolated from the chamber and the delivery side of the turbomolecular pump being isolated from the primary pump,
a second step following the first step in which the flow limiting means of the second isolation valve are disabled in order to carry out second primary pumping, which is faster than in the first step, to a second characteristic threshold, while maintaining the isolation of the turbomolecular pumping, and
a third step, following the second step, in which the first and third isolation valves are opened and the second isolation valve is closed in order to carry out secondary pumping by means of turbomolecular pumping upstream of the primary pumping, with the chamber isolated from the primary pump.

This rapidly decreases the total pressure in the lock chamber, and consequently the water vapor partial pressure is also decreased. Additionally, the turbomolecular pump is constantly maintained in operation at full speed and at low pressure, thus lengthening its service life and enabling pumping to be carried out immediately in the chamber as soon as the isolation valves are opened.

According to one or more characteristics of the method, considered individually or in combination,
the method includes a fourth step following the third step, in which the first isolation valve is closed, and the second isolation valve, for which the flow limiting means have been disabled, is opened to recommence primary pumping, with the turbomolecular pump isolated, when a third characteristic threshold is reached,
a neutral gas is injected during the fourth step,
the first and/or second and/or third characteristic thresholds are predetermined time intervals,
the first and/or second and/or third characteristic thresholds are predetermined pressure levels,
the second primary pumping is recommenced when the chamber receives a signal requesting the unloading of the substrate.

The invention also proposes equipment for implementing the method for lowering the pressure as described above, including a load lock comprising a chamber for lowering the pressure of the environment of at least one substrate from atmospheric pressure to a sub-atmospheric transfer pressure and at least one handling chamber communicating with the load lock for transferring the substrate into the handling chamber at the transfer pressure, said load lock including a gas pumping system comprising a primary pump and a turbomolecular pump whose intake is connected to the chamber via a first isolation valve and whose delivery side is connected upstream of the primary pump to a primary pumping circuit, the gas pumping system also including a bypass circuit of the turbomolecular pump which communicates, on the one hand, with the chamber upstream of the first isolation valve, and, on the other hand, with the primary pumping circuit, the bypass circuit including a second isolation valve comprising flow limiting means which can be activated and the primary pumping circuit including a third isolation valve positioned between the delivery side of the turbomolecular pump and the bypass circuit, the gas pumping system also including means for controlling the isolation valves.

According to one or more characteristics of the equipment, considered individually or in combination,
the second isolation valve includes a first main valve having a first conductance and a second restriction valve branched from the main valve and having a second conductance which is lower than the first conductance,
the equipment includes a processing unit for controlling the valves as a function of at least one output signal of a sensor of a characteristic parameter of the gases of the chamber,
the third valve is integrated in a peripheral casing of the turbomolecular pump to interact with a delivery aperture of the turbomolecular pump.

Other advantages and features of the invention will become clear in the light of the following description and the attached drawings, in which:

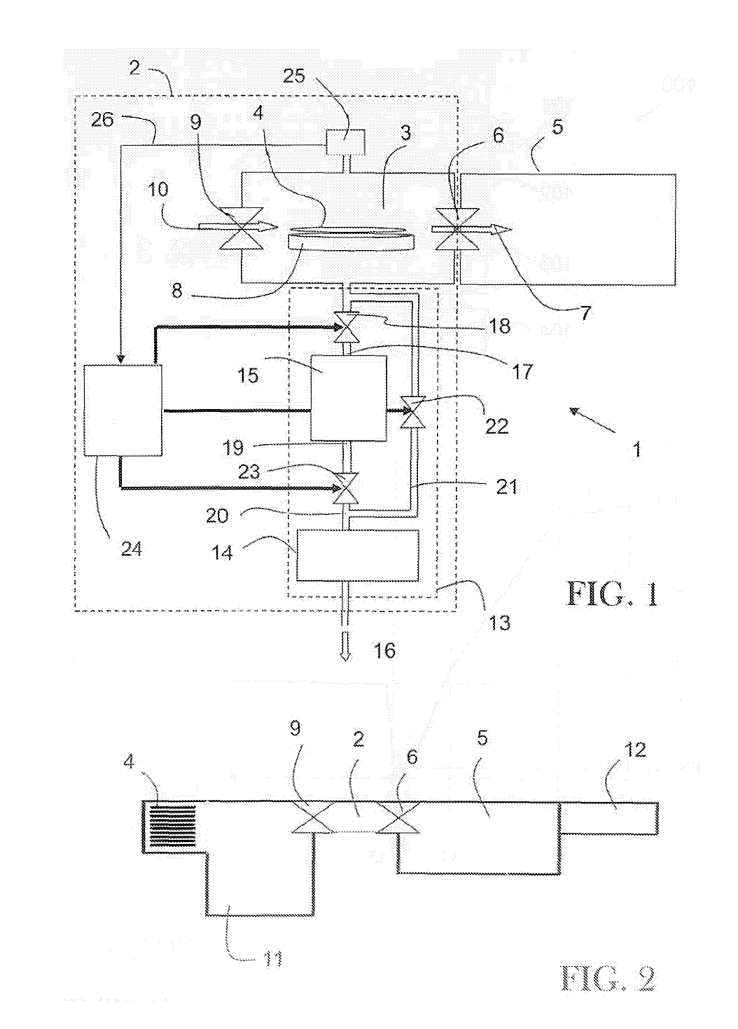

FIG. 1 is a schematic view of a load lock and of a handling chamber of a piece of equipment,

FIG. 2 is a schematic side view of a piece of equipment for manufacturing semiconductor components,

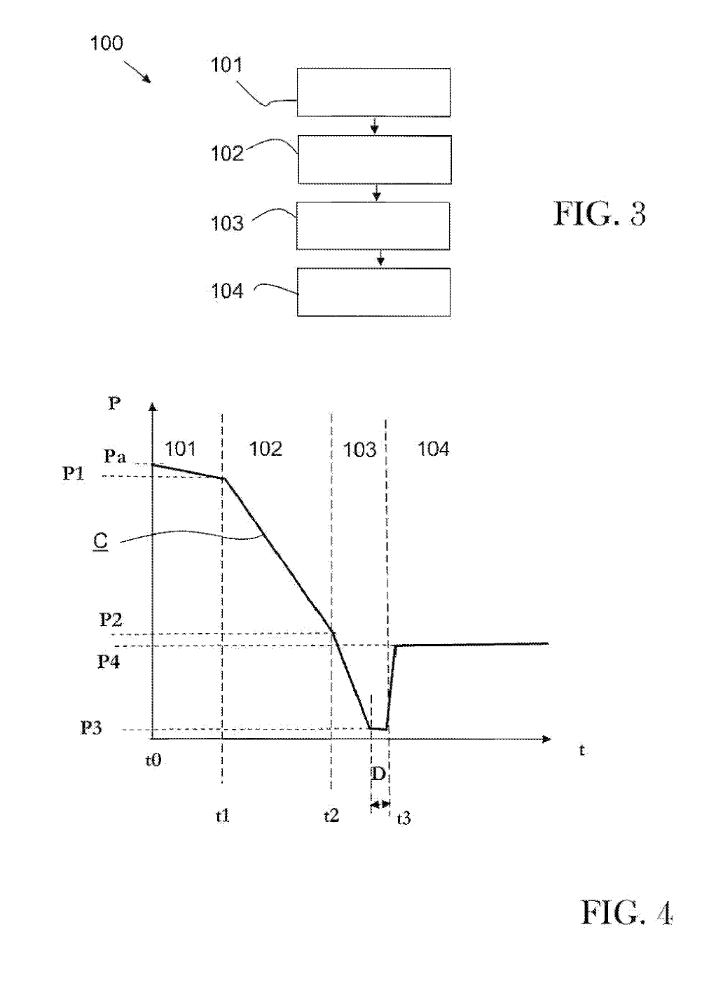

FIG. 3 is a schematic view of a method for lowering the pressure in a load lock, and

FIG. 4 is a graph showing a curve of pressure reduction in a load lock as a function of time.

In these drawings, identical elements are given the same reference numerals. For clarity, elements relating to the method are numbered from 100 onward.

The term “primary vacuum pressure” denotes a pressure of less than about 0.1 pascal, obtained by primary pumping. The term “secondary vacuum pressure” denotes a pressure of less than 0.1 pascal, obtained by secondary turbomolecular pumping.

FIG. 1 shows a piece of equipment 1 including a load lock 2 comprising a chamber 3 for lowering the pressure of the environment of at least one substrate 4 from atmospheric pressure to a sub-atmospheric transfer pressure.

The sub-atmospheric transfer pressure is, for example, a primary vacuum pressure, of about 0.01 pascal.

The equipment 1 also includes at least one handling chamber 5 communicating with the load lock 2 via a first lock door 6, for the transfer of the substrate 4 into the handling chamber 5 at the transfer pressure, in the direction of the arrow 7.

Said load lock 2 and the handling chamber 5 include a substrate carrier 8 and manipulation robots (not shown), used, notably, for supporting and transferring the substrate 4.

The chamber 3 is gas-tight and comprises a second lock door 9 which puts the interior of the chamber 3 into communication with an area at atmospheric pressure, such as a clean room or a mini-environment for equipment (also known as an “equipment front end module”), for loading at least one substrate 4 in the direction of the arrow 10.

Said load lock 2 also includes means for restoring atmospheric pressure (not shown), used to return the interior of the chamber 3 to atmospheric pressure, while the loading of a new substrate is awaited, and also after the loading of a substrate which has been processed in the handling chamber 2.

Thus the load lock 2 can be used to reduce the time required to change from atmospheric pressure to the sub-atmospheric transfer pressure, and to reduce contamination in the process or transfer chamber.

The equipment 1 is, for example, a piece of equipment for manufacturing semiconductor components. In this case, the handling chamber 5 is a process chamber or a transfer chamber.

In the case of simple (or “stand-alone”) equipment, the handling chamber 5 is a process chamber in which semiconductors are deposited or etched in layers of the substrate 4 in a controlled atmosphere at a secondary vacuum pressure, of about 10⁻³ pascal for example.

In the case of multiple (or “cluster”) equipment, the equipment can include one or more process chambers. In this case, the handling chamber 5 is a transfer chamber. In use, the transfer chamber is kept at a transfer pressure of the same order as the pressure of the process chamber, of about 10⁻² pascal for example. The atmosphere of the transfer chamber is maintained by a primary pump or a secondary pump in a controlled atmosphere of neutral gas such as nitrogen. The transfer chamber receives the substrate 4 from the load lock 2 at the transfer pressure and directs it to the appropriate process chamber.

FIG. 2 shows an example of multiple equipment for manufacturing semiconductor components, including an equipment mini-environment 11, a load lock 2, a transfer chamber 5 and a process chamber 12.

Said load lock 2 includes a gas pumping system 13 (FIG. 1) in communication with the chamber 3 for lowering the pressure in the chamber.

The gas pumping system 13 comprises a primary pump 14 and a turbomolecular pump 15 upstream of the primary pump 14 in the direction of flow of the pumped gases, represented by the arrow 16. The primary pump 14 can be a pump dedicated to said load lock 2 or can be the primary pump of another chamber of the equipment 1, such as the transfer chamber 5.

The intake 17 of the turbomolecular pump 15 is connected to the chamber 3 via a first isolation valve 18. The delivery side 19 of the turbomolecular pump 15 is connected upstream of the intake of the primary pump 14 to a primary pumping circuit 20.

The gas pumping system 13 also includes a bypass circuit 21 of the turbomolecular pump 15 which communicates, on the one hand, with the chamber 3, upstream of the first isolation valve 18, and, on the other hand, with the primary pumping circuit 20.

The bypass circuit 21 includes a second isolation valve comprising flow limiting means which can be activated. When activated, the flow limiting means enable the pumping speed of the primary pump 14 to be limited mechanically.

For example, the second isolation valve 22 includes a first main valve having a first conductance and a second restriction valve branched from the main valve and having a second conductance which is lower than the first conductance.

The primary pumping circuit 20 also includes a third isolation valve 23 placed between the delivery side 19 of the turbomolecular pump 15 and the bypass circuit 21.

It is also possible for the third valve 23 to be integrated in a peripheral casing of the turbomolecular pump 15 in such a way that the plug of the third valve 23 interacts directly with the delivery aperture of the turbomolecular pump.

A small turbomolecular pump such as the ATH30 pump marketed by Alcatel Lucent may be used. This pump has the advantage of being compact and therefore easily placed in the proximity of the chamber 3.

It is then possible to isolate the turbomolecular pump 15 completely in respect of operation at the intake 17 and at the delivery side 19, by closing the first and the third valve 18 and 23, thus creating, notably, a primary vacuum pressure at the delivery side 19 of the turbomolecular pump 15. This low pressure at the delivery side 19 enables the turbomolecular pump 15 to operate at full speed without excess power consumption and without the risk of failure.

The gas pumping system 13 also includes means for controlling the opening and closure of the isolation valves 18, 22, 23 as a function of characteristic thresholds.

For this purpose, the equipment 1 includes a processing unit 24. For example, the processing unit 24 controls the opening and/or closure of the valves 18, 22, 23 as a function of the elapsing of predetermined time intervals.

In another example, the processing unit 24 controls the valves 18, 22, 23 as a function of at least one output signal 26 of a sensor 25 which is connected to the chamber 3 for measuring a characteristic parameter of the gases of the chamber 3 of said load lock 2. The output signal 26 of the sensor 25 is connected to the processing unit 24 for controlling the valves 18, 22, as a function of the values of characteristic thresholds supplied by the output signal 26.

For example, the sensor 25 is a pressure sensor for indicating the pressure established in the chamber 3.

It would also be possible to have a sensor 25 which could provide an indication of the partial pressure of the gases in the chamber 3. For example, the sensor 25 can provide an indication of the partial pressure of water vapor in the chamber 3.

In a specific embodiment, the sensor 25 includes an indirectly excited cell and an electromagnetic excitation antenna supplied by a power generator, placed around the cell so as to form a plasma in the cell. The light radiation emitted by the plasma is subsequently captured and transmitted to an optical spectrometer. The transmission can be provided by an optical fiber or by a suitable connector. The optical spectrometer generates an output signal 26 of the detected optical spectrum, which is transmitted to the processing unit 24.

In another embodiment, the sensor 25 is a mass spectrometer.

The reduction of pressure in the load lock 2 of the equipment 1 from atmospheric pressure to a low transfer pressure is carried out progressively in at least three consecutive steps (see the process 100 shown in FIG. 3).

At least one substrate 4 is initially placed in the chamber 3 at atmospheric pressure. The first and second isolation valves 18, 22 are closed. It is also possible to close the third isolation valve 23. The primary pump 14 and turbomolecular pump 15 are in operation.

In a first step 101, a first primary pumping is carried out from atmospheric pressure to a first characteristic threshold. The pumping is carried out by means of the bypass circuit 21 of the primary pump 14 whose pumping speed is limited. The intake 17 of the turbomolecular pump 15 in operation is isolated from the chamber 3, and the delivery side 19 of the turbomolecular pump 15 is isolated from the primary pump 14. For this purpose, in the example considered in FIG. 1, the first and third isolation valves 18 and 23 are closed and the second isolation valve 22 is opened, the flow limiting means of the latter being activated, for example by having a second, lower, conductance, until a first characteristic threshold is reached.

Thus, in the first step 101, the turbomolecular pump 15 is completely isolated from the gases of the chamber 3 and of the bypass circuit 21, whose pressure, in the range from atmospheric pressure to a first primary sub-atmospheric pressure, could damage the turbomolecular pump 15.

This first step 101 enables slow primary pumping to be carried out from atmospheric pressure to the first characteristic threshold, at which the risk of contamination by excessively rapid primary pumping ceases to exist. By means of the slow pumping, the solidification of certain types of gas present in the gaseous atmosphere surrounding the substrate 4 can be prevented.

In a second step 102 following the first step 101, a second primary pumping is carried out, more rapidly than in the first step 101, to a second characteristic threshold, while the isolation of the turbomolecular pump is maintained.

For this purpose, the first and third isolation valves 18 and 23 are kept closed. The second isolation valve 22 is kept open and the flow limiting means are disabled, for example by making the isolation valve 22 have a first conductance which is greater than the second conductance, until a second characteristic threshold is passed. The pumping speed of the primary pump 14 is no longer limited.

The second characteristic threshold corresponds to the threshold at which the pressure at the intake 17 of the turbomolecular pump 15 is sufficiently low to have no effect on its operation.

Thus, in the second step 102, when the pressure in the chamber 3 is in the range from the first sub-atmospheric pressure to a second primary vacuum pressure, the turbomolecular pump 15 remains isolated at the intake 17 and at the delivery side 19, as a result of which the power consumption of the turbomolecular pump 15 is limited and its service life is increased.

In a third step 103, following the second step 102, secondary pumping is carried out by means of the turbomolecular pump upstream of the primary pumping, and the chamber 3 is isolated from the primary pumping. For this purpose, the first and third isolation valves 18 and 23 are opened, and the second isolation valve 22 is closed.

This third step 103 reduces the partial pressure of water vapor present in the residual gas mixture and accelerates the degassing of the substrates, thus increasing production efficiency.

Thus, in the third step 103, when the pressure in the chamber 3 is sufficiently low, the turbomolecular pump 15, whose operation at full speed has been maintained, can immediately lower the pressure in the chamber 3.

The process 100 can include a fourth step 104 following the third step 103, in which primary pumping is restarted with the turbomolecular pumping isolated when a third characteristic threshold is reached. For example, primary pumping is restarted when said load lock 2 receives a signal requesting the unloading of the substrate 4, which can be generated by the handling chamber 5.

For this purpose, the first isolation valve 18 is closed and the second isolation valve 22 is opened, with the flow limiting means of the latter disabled, for example by providing the first, higher, conductance when a third characteristic threshold has been passed in the third step 103. It is also possible to close the third isolation valve 23 immediately before opening the second isolation valve 22, to ensure that the delivery side 19 of the turbomolecular pump 15 is isolated at a primary vacuum pressure.

The fourth step 104 enables the gaseous atmosphere of the substrate 4 to be brought to the appropriate transfer pressure. Thus the steps of the process in the handling chamber 5 do not have to be modified to allow the entry of the substrate 4, because the same transfer pressure is retained.

It is also possible to inject a neutral gas, such as nitrogen, in the fourth step 104, to maintain the direction of flow of the gases towards the primary pumping.

The first and/or second and/or third characteristic thresholds can be predetermined time intervals. Alternatively or additionally, the first and/or second and/or third characteristic thresholds are predetermined pressure levels.

FIG. 4 is a graph showing a curve C of pressure reduction in a load lock 2 as a function of time.

At the initial time t0 on the graph, the atmosphere of the substrate 4 is at atmospheric pressure Pa.

In the first step 101, the pressure of the environment of the substrate 4 is lowered by slow pumping to a sub-atmospheric pressure P1, by means of the primary pump 14 whose pumping speed is limited. The pressure P1, of about fifty pascals for example, corresponds to the first characteristic threshold beyond which it is considered that there is no longer a risk of contamination by excessively fast primary pumping.

In the second step 102, the pressure of the environment of the substrate 4 is then lowered by fast pumping to a sub-atmospheric pressure P2, below the pressure P1, by means of the primary pump 14 whose pumping speed is no longer limited. Thus there is a break in the slope of the pressure lowering curve at the time t1, when the fast primary pumping is started. The pressure P2, of about 0.1 pascal for example, corresponds to the second characteristic threshold beyond which the turbomolecular pump can operate at full speed without any risk of damage.

In the third step 103, the pressure of the environment of the substrate 4 is then reduced to a sub-atmospheric pressure P3, of about 10⁻⁴ pascal, by means of the secondary pump 15. A second break in the slope of the pressure lowering curve is observed at the time t2 at which pumping is carried out by means of the turbomolecular pump 15.

In the fourth step 104, at the time t3, when a third characteristic threshold has been passed, the pressure of the environment of the substrate 4 rises again to a transfer pressure P4, corresponding to a primary vacuum pressure of about 10⁻² pascal. The pressure P4 is obtained by primary pumping with an injection of neutral gas. The third characteristic threshold corresponds, for example, to the end of a time interval D, of a few seconds, after the pressure of the chamber 3 has reached the sub-atmospheric pressure P3.

This rapidly decreases the total pressure in the chamber 3, and consequently the water vapor partial pressure, in a masked time interval. Additionally, the turbomolecular pump 15 is constantly kept at full operating speed and is under load at primary vacuum pressures only, as a result of which its service life is increased and there is no loss of time or efficiency when it is put into communication with the chamber 3. It is also possible to use a standard turbomolecular pump 15.

The method for lowering pressure is therefore simple, inexpensive to implement, and can be used for a rapid transition to a low pressure below the transfer pressure, in order to improve the conditioning of the substrate, while meeting the industrial constraints of reliability to provide high rates of pumping cycles for load locks.

1. A method for lowering the pressure in a load lock of equipment from atmospheric pressure to a sub-atmospheric transfer pressure, said load lock (2) including a chamber (3) in which at least one substrate (4) is placed at atmospheric pressure, and a gas pumping system (13) comprising a primary pump (14) and a turbomolecular pump (15) whose intake (17) is connected to the chamber (3) via a first isolation valve (18) and whose delivery side (19) is connected upstream of said primary pump (14) to a primary pumping circuit (20), said gas pumping system (13) additionally including a bypass circuit (21) of said turbomolecular pump (15) which communicates, on the one hand, with said chamber (3) upstream of said first isolation valve (18), and, on the other hand, with said primary pumping circuit (20), said bypass circuit (21) including a second isolation valve (22) comprising flow limiting means which can be activated, and said primary pumping circuit (20) including a third isolation valve (23) positioned between the delivery side (19) of the turbomolecular pump (15) and the bypass circuit (21), said method including:
a first step (101) in which said first and third isolation valves (18, 23) are closed, and said second isolation valve (22), for which the flow limiting means are activated, is opened, in order to carry out first primary pumping from atmospheric pressure to a first characteristic threshold through said bypass circuit (21) of said primary pump (14) whose pumping speed is limited, said intake (17) of said operating turbomolecular pump (15) being isolated from said chamber (3) and said delivery side (19) of said turbomolecular pump (15) being isolated from the primary pump (14),
a second step (102), following said first step (101), in which the flow limiting means of said second isolation valve (22) are disabled in order to carry out second primary pumping, which is faster than in said first step, to a second characteristic threshold, while maintaining the isolation of the turbomolecular pumping, and
a third step (103), following said second step (102), in which said first and third isolation valves (18, 23) are opened and said second isolation valve (22) is closed in order to carry out secondary pumping by means of said turbomolecular pumping upstream of the primary pumping, with the chamber (3) isolated from said primary pump (14).

2. The method for lowering pressure as claimed in claim 1, including a fourth step (104) following said third step (103), in which said first isolation valve (18) is closed, and said second isolation valve (22), for which the flow limiting means have been disabled, is opened to restore primary pumping, with the turbomolecular pump isolated, when a third characteristic threshold is reached.

3. The method for lowering pressure as claimed in claim 2, in which a neutral gas is injected during said fourth step (104).

4. The method for lowering pressure as claimed in claim 1, in which said first and/or second and/or third characteristic thresholds are predetermined time intervals.

5. The method for lowering pressure as claimed in claim 1, in which said first and/or second and/or third characteristic thresholds are predetermined pressure levels.

6. The method for lowering pressure as claimed in claim 2, wherein said second primary pumping is restarted when said load lock (2) receives a signal requesting the unloading of the substrate (4).

7. Equipment for implementing the method for lowering the pressure as claimed in claim 1, including a load lock (2) comprising a chamber (3) for lowering the pressure of the environment of at least one substrate (4) from atmospheric pressure to a sub-atmospheric transfer pressure and at least one handling chamber (5) communicating with said load lock (3) for transferring the substrate (4) into the handling chamber (5) at the transfer pressure, said load lock (2) including a gas pumping system (13) comprising a primary pump (14) and a turbomolecular pump (15) whose intake (17) is connected to the chamber (3) via a first isolation valve (18) and whose delivery side (19) is connected upstream of said primary pump (14) to a primary pumping circuit (20), said gas pumping system (13) also including a bypass circuit (21) of said turbomolecular pump (15) which communicates, on the one hand, with said chamber (3) upstream of said first isolation valve (18), and, on the other hand, with said primary pumping circuit (20), said bypass circuit (21) including a second isolation valve (22) comprising flow limiting means which can be activated and said primary pumping circuit (20) including a third isolation valve (23) positioned between the delivery side (19) of the turbomolecular pump (15) and the bypass circuit (21), said gas pumping system (13) also including means for controlling said isolation valves (18, 22, 23).

8. The equipment as claimed in claim 7, in which the second isolation valve (22) includes a first main valve having a first conductance and a second restriction valve branched from said main valve and having a second conductance which is lower than said first conductance.

9. The equipment as claimed in claim 7, including a processing unit (24) for controlling said valves (18, 22, 23) as a function of at least one output signal (26) of a sensor (25) of a characteristic parameter of the gases in said chamber (3).

10. The equipment as claimed in claim 7, wherein said third valve (23) is integrated into a peripheral casing of said turbomolecular pump (15) so as to interact with a delivery aperture of said turbomolecular pump (15).
